(19) United States
(12) Patent Application Publication
(10) Pub. No.: US 2026/0120906 A1
(43) Pub. Date: Apr. 30, 2026

(54) METHOD AND APPARATUS FOR REMOVING RADIONUCLIDES FROM RADIOACTIVE METAL WASTE

(71) Applicant: DOOSAN ENERBILITY CO., LTD., Changwon (KR)

(72) Inventors: Kwang Soo Park, Seoul (KR); Dong Hun Pak, Ulsan (KR); Tae Seob Lim, Seoul (KR); Chang Kyu Kim, Changwon (KR); Hae Woong Kim, Changwon (KR); Chung Sik Lim, Changwon (KR)

(21) Appl. No.: 19/354,904

(22) Filed: Oct. 10, 2025

(30) Foreign Application Priority Data
Oct. 28, 2024 (KR) 10-2024-0148722

(51) Int. Cl. G21F 9/30; G21F 9/00

(52) U.S. Cl. CPC G21F 9/30; G21F 9/004

(57) ABSTRACT

According to an embodiment of the disclosure, a method of removing radionuclides from radioactive metal waste is provided including a preheating step of preheating atmospheric gas to a target temperature; a supply step of supplying the atmospheric gas to the radioactive metal waste upon the atmospheric gas being preheated to the target temperature in the preheating step; an oxidation step of oxidizing a surface region of the radioactive metal waste by the atmospheric gas; and a removal step of removing an oxidized layer generated in the oxidation step.

### CROSS REFERENCE TO RELATED APPLICATION

The present application claims priority to Korean Patent Application No. 10-2024-0148722, filed Oct. 28, 2024, the entire contents of which is incorporated herein for all purposes by this reference.

### BACKGROUND OF THE INVENTION

### Field of the Invention

The disclosure relates to a method and apparatus for removing radionuclides from radioactive metal waste, and more particularly to a method and apparatus for removing radionuclides from radioactive metal waste, in which the radioactive metal waste is exposed to atmospheric gas at a target temperature or higher to oxidize a surface region of the radioactive metal waste, where most of the radionuclides are present, and to remove the oxidized layer.

### Description of the Related Art

As a conventional method of removing radionuclides from radioactive waste, melting decontamination involves melting scrap containing the radionuclides by using an air induction melting furnace or the like, adding appropriate slag to absorb some of the radionuclides into a slag layer, and casting the remaining molten steel into ingots.

Such a conventional melting decontamination method using slag treatment allows only the removal of radionuclides by oxidation-reduction reactions. Therefore, a problem arises in that elements such as Co, Fe, Mn and Ni, which cannot be removed by the oxidation-reduction reactions, remain in the ingots. In addition, a melting operation is performed at high temperatures, and thus isotopes such as Ag, Cs, Na, Se, Te and Zn volatilize and exist in the form of dust, thereby making it difficult to remove them by the slag treatment as well.

Further, the existing blasting, laser, and plasma decontamination methods can only remove contamination adhered to the outer surface of metallic radioactive waste.

### SUMMARY OF THE INVENTION

Because radionuclides in radioactive waste are concentrated in a surface region, there is a need for a technical means for selectively and efficiently removing the radionuclides from the surface region.

Accordingly, the disclosure provides a method and apparatus for removing radionuclides from radioactive metal waste, in which the radioactive metal waste is exposed to atmospheric gas at a target temperature or higher to oxidize a surface region of the radioactive metal waste, where most of the radionuclides are present, and to remove the oxidized layer.

The technical problems to be solved by the disclosure are not limited to those mentioned above, and other unmentioned technical problems will be clearly understood from the following descriptions by a person having ordinary knowledge in the art to which the disclosure pertains.

According to an embodiment of the disclosure, a method of removing radionuclides from radioactive metal waste is provided including the steps of: a preheating step of preheating atmospheric gas to a target temperature; a supply step of supplying the atmospheric gas to the radioactive metal waste when the atmospheric gas is preheated to the target temperature in the preheating step; an oxidation step of oxidizing a surface region of the radioactive metal waste by the atmospheric gas; and a removal step of removing an oxidized layer generated in the oxidation step.

According to an embodiment, the radioactive metal waste may be pretreated before the supply step is performed.

According to an embodiment, an oxidation rate of the radioactive metal waste may be faster than a diffusion rate of the radionuclides in the radioactive metal waste.

According to an embodiment, the oxidation rate of the radioactive metal waste at the surface may be 10 μm per hour or more.

According to an embodiment, the removal step may include vibrating the radioactive metal waste using a vibration device.

According to an embodiment, the removal step may include allowing the oxidized layer of the radioactive metal waste to fall by gravity.

According to an embodiment, the removal step may include dropping the oxidized layer separated from the radioactive metal waste using a blower.

According to an embodiment, the removal step may be performed simultaneously with the oxidation step.

According to an embodiment, the method may further include a determination step of determining whether the radioactive metal waste has reached a target decontamination level, after the removal step.

According to an embodiment of the disclosure, an apparatus for removing radionuclides from radioactive metal waste includes: a preheating furnace to which atmospheric gas is supplied and in which a preheating burner is provided to preheat the atmospheric gas to a target temperature; an oxidation reactor into which the radioactive metal waste is loaded; an atmospheric gas supply pipe through which the preheating furnace and the oxidation reactor communicate; and an on/off valve which is provided in the atmospheric gas supply pipe and controls flow of the atmospheric gas to be supplied to the oxidation reactor, wherein oxidation occurs in a surface region of the radioactive metal waste when the atmospheric gas is supplied to the oxidation reactor by opening the on/off valve.

According to an embodiment, the on/off valve may be opened when the atmospheric gas reaches a target temperature in the preheating furnace.

According to an embodiment, the oxidation reactor may include a pretreatment device to pretreat the radioactive metal waste before oxidation.

According to an embodiment, an oxidation rate of the radioactive metal waste may be faster than a diffusion rate of the radionuclides in the radioactive metal waste.

According to an embodiment, the oxidation rate of the radioactive metal waste at the surface may be 10 μm per hour or more.

According to an embodiment, the oxidation reactor may include a vibration device to remove an oxidized layer of the radioactive metal waste by vibrating the radioactive metal waste.

According to an embodiment, the vibration of the vibration device may cause the oxidized layer to separate from the radioactive metal waste and then fall by gravity.

According to an embodiment, the oxidation reactor may further include a blower to drop the oxidized layer separated from the radioactive metal waste.

According to an embodiment, the vibration of the radioactive metal waste by the vibration device may be performed simultaneously the oxidation of the radioactive metal waste.

According to an embodiment, the apparatus may further include an oxidized layer collection unit placed in a lower portion of the oxidation reactor and collecting the falling oxidized layer.

According to an embodiment, the oxidized layer collection unit may be detachable from the oxidation reactor.

According to the disclosure, the surface region of the radioactive metal waste, where most of the radionuclides are present, is oxidized and the oxidized layer is removed, thereby effectively removing the radionuclides from the radioactive metal waste, i.e., improving the decontamination efficiency of the radioactive metal waste.

In particular, because most of the radionuclides are present within a depth of 70 μm from the surface of the radioactive metal waste, effective decontamination can be achieved by removing the radionuclides from the surface region of the radioactive metal waste.

Further, the vibration device is used to vibrate the radioactive metal waste when the oxidized layer is removed, thereby effectively separating the oxidized layer from the radioactive metal waste. In addition, the blower is used to effectively drop the separated oxidized layer while preventing the separated oxidized layer from sticking to the vibration device and the like and failing to fall.

Furthermore, unlike conventional melting pretreatment technologies such as blasting, laser and plasma decontaminations, the decontamination method based on surface oxidation significantly reduces the amount of secondary waste, and removes radionuclides that have penetrated a metal base material.

The effects of the disclosure are not limited to those mentioned above, and it should be understood that the effects of the disclosure include all effects inferable from the foregoing detailed description or the appended claims.

### BRIEF DESCRIPTION OF THE DRAWINGS

FIG. 1 is a schematic diagram schematically showing an apparatus for removing radionuclides from radioactive metal waste according to an embodiment of the disclosure.

FIG. 2 is a schematic diagram showing another state of FIG. 1.

FIG. 3 is a flowchart showing a method of removing radionuclides from radioactive metal waste according to an embodiment of the disclosure.

### DETAILED DESCRIPTION OF THE INVENTION

Below, exemplary embodiments of a method and apparatus for removing radionuclides from radioactive metal waste according to the disclosure will be described with reference to the accompanying drawings.

In addition, the terms described below are terms defined in consideration of functions in the disclosure, and these terms may vary with the intention or practice of a user or an operator. The following embodiments are not intended to limit the scope of the disclosure but are merely for the purpose of describing the components set forth in the appended claims.

For clear description of the disclosure, parts irrelevant to the description are omitted, and the same reference numerals refer to identical or similar components throughout the specification. In the whole specification, it will be understood that when a component is referred to as “including” any component, it does not exclude other components but may further include the other components unless otherwise specified.

Regarding an element with a suffix such as ‘unit’, two or more elements may be combined into one element, or one element may be divided into two or more elements according to functions. In addition, each of respective elements to be described below may additionally perform some or all functions among functions which other elements take charge of in addition to a primary function which each element takes charge of and some functions among primary functions which the respective elements take charge of may be exclusively performed by other elements.

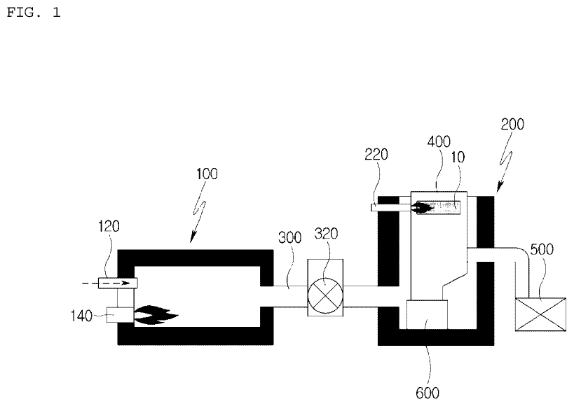

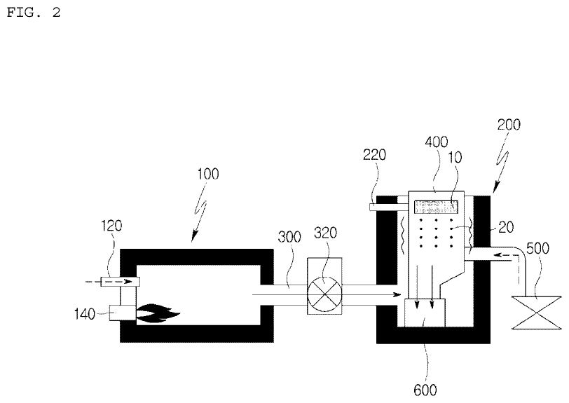

First, the apparatus for removing the radionuclides from the radioactive metal waste according to an embodiment of the disclosure will be described with reference to FIGS. 1 and 2.

The foregoing removal apparatus may include a preheating furnace 100, a preheating burner 140, an oxidation reactor 200, a pretreatment device 220, an atmospheric gas supply pipe 300, an on/off valve 320, a vibration device 400, a blower 500, and an oxidized layer collection unit 600.

The preheating furnace 100 may be configured to preheat atmospheric gas to a target temperature, and includes an inlet pipe 120 through which the atmospheric gas is supplied to the preheating furnace 100. In addition, the preheating furnace 100 may be provided with the preheating burner 140 that heats the atmospheric gas inside the preheating furnace 100 to the target temperature. The preheating burner 140 may be referred to as an atmospheric gas preheating burner.

The oxidation reactor 200 may be configured to oxidize the surface of radioactive metal waste 10, thereby decontaminating the radioactive metal waste 10. The radioactive metal waste 10 is loaded into the oxidation reactor 200. In particular, the radioactive metal waste 10 is placed in the vibration device 400 provided in the oxidation reactor 200. The radioactive metal waste 10 may be loaded into the vibration device 400 in a batch or continuous manner.

The atmospheric gas supply pipe 300 may connect the preheating furnace 100 and the oxidation reactor 200 to allow them to communicate with each other. Thus, the atmospheric gas can be supplied from the preheating furnace 100 to the oxidation reactor 200. The atmospheric gas supply pipe 300 may be provided with the on/off valve 320 to control the flow of the atmospheric gas to be supplied to the oxidation reactor 200.

When the on/off valve 320 is opened to supply the atmospheric gas from the preheating furnace 100 to the oxidation reactor 200, the surface region of the radioactive metal waste 10 is oxidized.

In this case, the on/off valve 320 may be configured to open when the atmospheric gas in the preheating furnace 100 reaches the target temperature. Thus, the radioactive metal waste 10 can be exposed to the atmospheric gas at the target temperature or higher, and the surface region of the radioactive metal waste 10 can be effectively oxidized. The supply of the atmospheric gas at or above the target temperature may be maintained for a period of time required to achieve a target decontamination level.

The apparatus for removing radionuclides from radioactive metal waste may further include a controller, a first temperature sensor and a second temperature sensor. The controller may be configured to control operations of all elements of the apparatus for removing radionuclides from radioactive metal waste.

The first temperature may be installed in the preheating furnace 100 to detect the temperature of the atmospheric gas inside preheating furnace 100. According to an embodiment, the first temperature sensor may be installed at the atmospheric gas supply pipe 300, specifically, between the preheating furnace 100 and the on/off valve 320. When the first temperature sensor is installed at the atmospheric ga supply pipe 300, the temperature of the atmospheric gas that is delivered to the oxidation reactor 200 may be more accurately measured.

The second temperature sensor may be installed in the oxidation reactor 200 to detect the temperature inside the oxidation reactor 200. According to an embodiment, the second temperature sensor may be installed in the vibration device 400 to detect the temperature inside the vibration device where the radioactive metal waste 10 is placed.

The controller may be configured to control the on/off valve 320 to open when the temperature that is detected by the first temperature sensor is equal to or higher than the target temperature.

The type of atmospheric gas and the target temperature may be appropriately selected according to the steel grade of the radioactive metal waste 10. For example, when the radioactive metal waste 10 is Inconel 725, the atmospheric gas may be H₂S, and the target temperature may be 750° C. In other words, H₂S gas at 750° C. or higher may be supplied to the radioactive metal waste 10 to oxidize the surface of the radioactive metal waste 10. In this case, the period of time for which the supply of H₂S gas at 750° C. or higher is maintained to remove the radionuclides by oxidizing the surface of the radioactive metal waste 10 to a depth of 70 μm is no more than 10 minutes.

According to an embodiment, the controller may be configured to receive information on the steel grade of the radioactive metal waste 10, and automatically select the type of atmospheric gas and set the target temperature according to the information on the steel grade of the radioactive metal waste 10. Furthermore, the controller may determine a minimum time period to maintain the on/off valve 320 in an open state according to the information on the steel grade of the radioactive metal waste 10, the type of the atmospheric gas and the target temperature. Then, the controller may control the on/off valve 320 to close based on the minimum time period (e.g., after expiration of the minimum time period).

For example, when the received information on the steel grade of the radioactive metal waste 10 is Inconel 725, the controller may be configured to automatically select H₂S as the atmospheric gas, set the target temperature as 750° C. and determine the minimum time period as 10 minutes. The controller may control the on/off valve 320 to close based on the minimum time period and the temperature detected by the second temperature sensor to allow the radioactive metal waste 10 to be sufficiently decontaminated. For example, the controller may extend the time period for maintain the on/off valve 320 in the open state beyond the minimum time period if the temperature detected by the second temperature sensor during the minimum time period is lower than the target temperature.

The controller may determine whether the target decontamination level is reached by various criteria. According to an embodiment, the vibration device 400 may include a weight sensor that senses the weight change of the radio metal waste 10. The controller may determine that the target decontamination level is reached when the weight change of the radio metal waste 10 is equal to or higher than a threshold value. Accordingly to another embodiment, the controller may set a target time period based on the amount of the radio metal waste 10, the temperature of the atmospheric as supplied to the oxidation rector 200, the temperature of the preheated radioactive metal waste 10, and determine that the target decontamination level is reached when the target time period has passed.

The pretreatment device 220 may be provided in the oxidation reactor 200 to pretreat the radioactive metal waste 10 before the oxidation of the radioactive metal waste 10. The pretreatment may correspond to preheating, in which case the pretreatment device 220 may be implemented as a preheating burner. Such pretreatment generates heat on the surface of the radioactive metal waste 10, thereby increasing the efficiency of subsequent oxidized layer removal. The preheating burner of the pretreatment device 220 may be referred to as a radioactive metal waste preheating burner.

The pretreatment of the radioactive metal waste 10 may be performed before the atmospheric gas is heated to the target temperature in the preheating furnace 100, i.e., before the on/off valve 320 is opened to supply the atmospheric gas to the oxidation reactor 200 through the atmospheric gas supply pipe 300.

According to an embodiment, the controller may control operation of the pretreatment device 220. The controller may control the preheater 140 and the pretreatment device 220 to respectively heat the atmospheric gas and the radioactive metal waste 10 simultaneously or concurrently before opening the on/off valve 320. Then, the controller may control the on/off valve 320 to open when both the atmospheric gas and the radioactive metal waste 10 reach their respective target temperatures.

As described above, the atmospheric gas at or above the target temperature is supplied to the radioactive metal waste 10, thereby making an oxidation rate (i.e., a rate of forming the oxidized layer) of the radioactive metal waste 10 faster than a diffusion rate of the radionuclides in the radioactive metal waste 10 when the surface of the radioactive metal waste 10 is oxidized. To this end, the oxidation rate of the radioactive metal waste 10 at the surface may be 10 μm per hour or more. Accordingly, the radionuclides on the surface of the radioactive metal waste 10 can be easily removed as the oxidized layer.

Meanwhile, the vibration device 400 may be provided in the oxidation reactor 200 and vibrates the radioactive metal waste 10 thereby remove the oxidized layer of the radioactive metal waste 10. When the radioactive metal waste 10 is vibrated by the vibration device 400, the oxidized layer is separated from the radioactive metal waste 10 and then falls by gravity. FIG. 2 illustrates the falling oxidized layer 20.

The vibration of the radioactive metal waste 10 by the vibration device 400 may be performed simultaneously with the surface oxidation of the radioactive metal waste 10. In other words, the generation and removal of the oxidized layer on the surface of the radioactive metal waste 10 may occur simultaneously or concurrently. In this way, by using the vibration device 400, the oxidized layer formed on the surface of the radioactive metal waste 10 can be easily separated.

FIG. 1 illustrates a state in which the on/off valve 320 is closed not to supply the atmospheric gas to the oxidation reactor 200, and the radioactive metal waste 10 is being pretreated by the pretreatment device 220. Further, FIG. 2 illustrates a state in which the on/off valve 320 is opened to supply the atmospheric gas to the oxidation reactor 200, and the surface oxidation of the radioactive metal waste 10 and the removal of the oxidized layer are being carried out.

In this case, most of the radionuclides are removed as part of the oxidized layer; however, a small number of radionuclides (e.g., Cs-134, Cs-137, etc.) may exhibit volatilization behavior during oxidation and may migrate as dust. Therefore, a bag filter or a similar device may be additionally provided to capture such dust.

The blower 500 may be provided in the oxidation reactor 200 to drop the oxidized layer separated from the radioactive metal waste 10. The blower 500 may operate in conjunction with the vibration device 400 to prevent the oxidized layer, which has been separated from the surface of the radioactive metal waste 10 by the vibration, from re-sticking to the vibration device 400 and the like and failing to fall, thereby ensuring that the separated oxidized layer falls effectively.

The falling oxidized layer 20 may be collected by the oxidized layer collection unit 600 placed in a lower portion of the oxidation reactor 200. The oxidized layer collection unit 600 may be a container with its upper side open so that it can receive the falling oxidized layer. The oxidized layer collection unit 600 may be configured to be detachable from the oxidation reactor 200. Thus, when the radioactive metal waste 10 reaches the target decontamination level and the removal operation is terminated, the oxidized layer collection unit 600 may be detached from the oxidation reactor 200 and treated. Further, the decontaminated radioactive metal waste 10 may undergo radiation dosimetry and then be transferred to a melting furnace.

According to the disclosure, the surface region of the radioactive metal waste, where most of the radionuclides are present, may be oxidized and then the resulting oxidized layer may be removed, thereby effectively removing the radionuclides from the radioactive metal waste 10 and improving its decontamination efficiency.

The disclosure is characterized in that the oxidized layer is generated through control of a specific gas atmosphere and temperature, and is then removed, in order to effectively eliminate radioactive elements concentrated on the surface of the radioactive metal waste prior to volume reduction of the radioactive metal waste through melting. This is based on the recognition that the radionuclides in the radioactive metal waste are densely concentrated in the surface region and decrease exponentially as the depth increases from the surface.

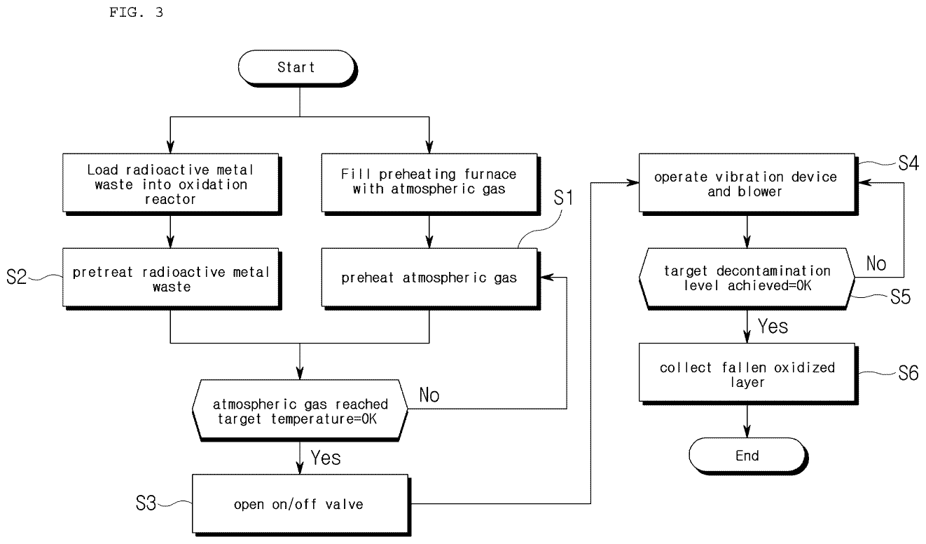

Next, a method of removing the radionuclides from the radioactive metal waste according to an embodiment of the disclosure will be described with reference to FIG. 3. Each operation may be performed automatically under the control of the controller.

The removal method may include a preheating step S1 of preheating the atmospheric gas to the target temperature, a supply step S3 of supplying the atmospheric gas to the radioactive metal waste 10 when the atmospheric gas has been preheated to the target temperature in the preheating step S1, an oxidation step of oxidizing the surface region of the radioactive metal waste 10 by the atmospheric gas, and a removal step S4 of removing the oxidized layer generated in the oxidation step.

Further, according to an embodiment, the radioactive metal waste 10 may undergo a pretreatment step S2 in which it is pretreated before being oxidized in the oxidation step.

In the supply step S3, as described above, the on/off valve 320 may be controlled to open when the atmospheric gas in the preheating furnace 100 reaches the target temperature, so that the atmospheric gas can be supplied to the oxidation reactor 200.

Here, the oxidation step and the removal step S4 may be performed simultaneously. In the removal step S4, as described above, the radioactive metal waste 10 may be vibrated using the vibration device 400, and the oxidized layer may be separated from the radioactive metal waste 10 by the vibration and falls by gravity.

Further, in the removal step S4, the blower 500 may be used in conjunction with the vibration device 400 to ensure that the oxidized layer separated from the radioactive metal waste 10 falls without sticking to the vibration device 400 and the like.

After the removal step S4, a determination step S5 is performed to determine whether the radioactive metal waste 10 has reached the target decontamination level. When it is determined in the determination step S5 that the radioactive metal waste 10 has reached the target decontamination level, the removal operation is terminated and a collection step S6 for collecting the fallen oxidized layer may be performed. In the collection step S6, as described above, the oxidized layer collection unit 600 may be detached from the oxidation reactor 200 and treated separately.

The disclosure is not limited to the specific embodiments and descriptions described above, and various modifications can be made by a person having ordinary knowledge in the art, to which the disclosure pertains, without departing from the gist of the disclosure as claimed in the claims, and such modifications fall within the scope of the disclosure. Also, it is noted that any one feature of an embodiment of the present disclosure described in the specification may be applied to another embodiment of the present disclosure. Similarly, the present invention encompasses any embodiment that combines features of one embodiment and features of another embodiment.

### DESCRIPTION OF REFERENCE NUMERALS

10: radioactive metal waste
20: falling oxidized layer
100: preheating furnace
120: inlet pipe
140: preheating burner
200: oxidation reactor
220: pretreatment device
300: atmospheric gas supply pipe
320: on/off valve
400: vibration device
500: blower
600: oxidized layer collection unit
S1: preheating step
S2: pretreatment step
S3: supply step
S4: removal step
S5: determination step
S6: collection step

What is claimed is:

1. A method of removing radionuclides from radioactive metal waste, comprising:
a preheating step of preheating atmospheric gas to a target temperature;
a supply step of supplying the atmospheric gas to the radioactive metal waste upon the atmospheric gas being preheated to the target temperature in the preheating step;
an oxidation step of oxidizing a surface region of the radioactive metal waste by the atmospheric gas; and
a removal step of removing an oxidized layer generated in the oxidation step.

2. The method of claim 1, wherein the radioactive metal waste is pretreated before the supply step is performed.

3. The method of claim 1, wherein an oxidation rate of the radioactive metal waste is faster than a diffusion rate of the radionuclides in the radioactive metal waste.

4. The method of claim 3, wherein the oxidation rate of the radioactive metal waste at the surface is 10 μm per hour or more.

5. The method of claim 1, wherein the removal step comprises vibrating the radioactive metal waste using a vibration device.

6. The method of claim 5, wherein the removal step comprises allowing the oxidized layer of the radioactive metal waste to fall by gravity.

7. The method of claim 6, wherein the removal step comprises dropping the oxidized layer separated from the radioactive metal waste using a blower.

8. The method of claim 5, wherein the removal step is performed simultaneously with the oxidation step.

9. The method of claim 1, further comprising a determination step of determining whether the radioactive metal waste has reached a target decontamination level, after the removal step.

10. An apparatus for removing radionuclides from radioactive metal waste, comprising:
a preheating furnace to which atmospheric gas is supplied and in which a preheating burner is provided to preheat the atmospheric gas to a target temperature;
an oxidation reactor into which the radioactive metal waste is loaded;
an atmospheric gas supply pipe through which the preheating furnace and the oxidation reactor communicate; and
an on/off valve which is provided in the atmospheric gas supply pipe and controls flow of the atmospheric gas to be supplied to the oxidation reactor,
wherein oxidation occurs in a surface region of the radioactive metal waste upon supplying the atmospheric gas to the oxidation reactor by opening the on/off valve.

11. The apparatus of claim 10, wherein the on/off valve is opened upon the atmospheric gas reaching a target temperature in the preheating furnace.

12. The apparatus of claim 10, wherein the oxidation reactor comprises a pretreatment device to pretreat the radioactive metal waste before oxidation.

13. The apparatus of claim 10, wherein an oxidation rate of the radioactive metal waste is faster than a diffusion rate of the radionuclides in the radioactive metal waste.

14. The apparatus of claim 13, wherein the oxidation rate of the radioactive metal waste at the surface is 10 μm per hour or more.

15. The apparatus of claim 10, wherein the oxidation reactor comprises a vibration device to remove an oxidized layer of the radioactive metal waste by vibrating the radioactive metal waste.

16. The apparatus of claim 15, wherein the vibration of the vibration device causes the oxidized layer to separate from the radioactive metal waste and then fall by gravity.

17. The apparatus of claim 16, wherein the oxidation reactor further comprises a blower to drop the oxidized layer separated from the radioactive metal waste.

18. The apparatus of claim 15, wherein the vibration of the radioactive metal waste by the vibration device is performed simultaneously the oxidation of the radioactive metal waste.

19. The apparatus of claim 16, further comprising an oxidized layer collection unit placed in a lower portion of the oxidation reactor and collecting the falling oxidized layer.

20. The apparatus of claim 19, wherein the oxidized layer collection unit is detachable from the oxidation reactor.
